(19) United States
(12) Patent Application Publication
(10) Pub. No.: US 2026/0316029 A1
(43) Pub. Date: Oct. 15, 2026

(54) METHODS AND APPARATUS FOR CONTROLLED DISCHARGE OF COMPONENTS FROM A TUBE

(71) Applicant: Johnson Matthey Davy Technologies Limited, London (GB)

(72) Inventors: Ben Geoffrey MALLAM, Stockton-On-Tees (GB); Jay Simon CLARKSON, Stockton-On-Tees (GB)

(21) Appl. No.: 19/104,314

(22) PCT Filed: Sep. 21, 2023
(86) PCT No.: PCT/GB2023/052445

§ 371 Date: Feb. 17, 2025

(30) Foreign Application Priority Data
Sep. 26, 2022 (GB) 2213993.5

(51) Int. Cl. B01J 8/00; B01J 4/00

(52) U.S. Cl. CPC B01J 8/0035; B01J 4/001; B01J 8/003; B01J 2208/00761; B01J 2208/00814

(57) ABSTRACT

A conveyor, a system and a method for controlled discharge of a stack of components from a tube, the conveyor comprising: i) a frame configured to be located in proximity to an outlet of the tube; and ii) a plurality of feed elements mounted to the frame. The feed elements being distributed around and along a feed path that extends through the frame so as to contact, in use, components passing through the frame along the feed path. One or more of the feed elements comprise a tensioning mechanism for adjusting a level of friction between said one or more of the feed elements and the components passing through the frame along the feed path.

The present disclosure relates to methods and apparatus for the controlled discharge of components from a tube. In particular, methods and apparatus for the controlled discharge of catalyst carriers from a reactor tube of a tubular reactor.

### BACKGROUND

Conventional, so-called fixed-bed tubular, reactors comprise a reactor shell containing a plurality of tubes, which are usually cylindrical, and which are usually directly filled with catalyst particles. In use, a heat-transfer medium flows through the shell of the reactor outside these tubes and thereby adjusts the temperature of the catalyst in the tubes by heat exchange across the tube wall. Thus, where the reaction is an exothermic reaction, the heat-transfer medium will allow heat to be removed from the catalyst and where the reaction is an endothermic reaction, the heat-transfer medium will provide heat to the catalyst.

For some reactions, the heat effects of the reaction are moderate such that they are either not problematic or they can be readily managed. In some cases, the heat effects are sufficiently small that large-diameter tubes may be used. This has the benefit that there is a large volume of catalyst within the tube.

However, for more exothermic or endothermic reactions it is necessary that there is efficient heat transfer via the tube wall to the heat transfer medium to enable the conditions within the reactor to be controlled, in order to maintain a stable operating temperature to avoid detrimental effects occurring. Such effects, for exothermic reactions, may include side reactions taking place, damage to the catalyst such as by sintering of the catalytic active sites, and, in a worst case, thermal runaway. Detrimental effects for endothermic reactions may include quenching of the reaction.

To achieve the desired efficiency, the surface area of the tube wall per unit length has to be maximised. This has in the past been achieved by installing a greater number of smaller-diameter tubes. In some reactions, the size restriction means that the tubes are only of the order of about 15 to 40 mm internal diameter. However, the use of this multiplicity of tubes increases the cost and complexity of the reactor.

Thus, in an attempt to mitigate these problems, an alternative approach has been developed, in particular for more exothermic or endothermic reactions, in which the catalyst is not directly packed into the reactor tubes but is instead contained in a plurality of catalyst carriers that are configured to sit within the reactor tube.

WO2011/048361, WO2012/136971 and WO2016/050520 describe some examples of catalyst carriers configured for use in tubular reactors.

Catalyst carriers may usefully be used for a wide range of processes. Examples of suitable uses include processes and reactors for exothermic reactions such as reactions for the production of methanol, reactions for the production of ammonia, methanation reactions, shift reactions, oxidation reactions such as the formation of maleic anhydride and ethylene oxide reactions and the like. A particular example where catalyst carriers may be used is in processes and reactors for performing the Fischer-Tropsch reaction. Catalyst carriers may also be used for endothermic reactions such as pre-reforming, dehydrogenation and the like.

Each reactor tube may contain a large number of catalyst carriers, and a single tubular reactor may contain a large number of reactor tubes. Typically, each catalyst carrier comprises a seal that engages with an inner wall of the reactor tube. The seal may function to channel fluids through an interior of the catalyst carrier in use and also may function to provide physical support to help maintain the vertical position of the catalyst carrier within the reactor tube.

From time to time it may be necessary to discharge the catalyst carriers from one or more of the reactor tubes. This may be, for example, for the purposes of maintenance of the tubular reactor or replacement of the catalyst carriers.

The present disclosure seeks to provide improvements to the discharge of components from a tube, as an example improving the discharge of catalyst carriers from reactor tubes.

### SUMMARY OF THE DISCLOSURE

In a first aspect of the present disclosure there is provided a conveyor for controlled discharge of a stack of components from a tube, comprising:
i) a frame configured to be located in proximity to an outlet of the tube; and
ii) a plurality of feed elements mounted to the frame, the feed elements being distributed around and along a feed path that extends through the frame so as to contact, in use, components passing through the frame along the feed path;
wherein one or more of the feed elements comprises a tensioning mechanism for adjusting a level of friction between said one or more of the feed elements and the components passing through the frame along the feed path.

Beneficially, the conveyor may assist in the controlled discharge of the components. This has advantages both for the discharge of components from the outlet of the tube and also, optionally, for the simultaneous insertion of components into an inlet of the tube. In particular, the feed elements with their tensioning mechanisms may permit the controlled passage of the components through the feed path by providing a controllable and adjustable frictional resistance to movement of the components. The controlled passage of the components through the feed path permits the speed and timing of the discharge of the components to be controlled. It also, optionally, permits components to be inserted in a controlled manner at the same time into the inlet of the tube. In particular, the conveyor may enable the insertion of components into the inlet of the tube to be controlled by the action of discharging components from the outlet of the tube, rather than the other way round.

This may be especially advantageous where the components are not self-supporting within the tube, i.e. they would naturally slide down the tube towards the outlet under the action of gravity alone. Such non-self-supporting components when inserted into an empty or partially empty tube would potentially be damaged by falling within the tube and impacting against a base of the tube or an uppermost component of a stack within the tube. For this reason, it has been typically preferred in the example case of catalyst carriers within reactor tubes to use components that are self-supporting, e.g. by providing seals on the catalyst carriers that frictionally engage against the inner wall of the tube. However, this solution increases the force required to insert the components into the tube which then may require machine assistance, e.g. use of a hydraulic ram to insert the components. Beneficially, the present conveyor may enable the use of non-self-supporting components within a tube and enable a safe and controllable method of filling and/or emptying and/or exchanging the components of the tube.

This beneficial reduces the chances of spontaneous or uncontrolled discharge of components. This is a particular benefit where, as in the case of catalyst carriers, the components may each have a reasonable mass and the stack of components may contain a reasonably large number of components leading to a potentially high cumulative mass acting on the lowermost components nearest the outlet of the reactor tube. A high cumulative mass within the stack of components may lead to uncontrolled discharge, especially in the eventuality that the physical integrity of the components has changed over time.

In some examples, each of the plurality of feed elements comprises a tensioning mechanism.

In some examples, the plurality of feed elements comprise feed elements at two, optionally at three or more, levels along the feed path. Beneficially, increasing the number of levels of feed elements present may reduce the risk of lateral deflection of the components during feeding by reducing the vertical spacing between adjacent levels. In some examples, the components may be connected together by, for example, a frictional push-fit, and reducing lateral deflection during discharge may beneficially reduce the risk of components disconnecting from each other spontaneously.

Preferably, the plurality of feed elements comprise at least upper feed elements and lower feed elements.

In some examples, a spacing between the upper feed elements and the lower feed elements is substantially equal to the longitudinal length of the each of the components. This may be particularly beneficial where the components each have a common external configuration and each comprise a feature, for example, an enlarged portion at one point along the length of the component, for example a seal in the case of catalyst carriers, that must be fed past the feed elements. By configuring the spacing between the upper and lower feed elements to be substantially equal to the longitudinal length of the component, it may be ensured that the feature, e.g. seal, of neighbouring components both contact a feed element at the same time. This configuration may be used as a natural brake to the discharge of the components helping to prevent spontaneous discharge of components due to gravity alone. For example, the tensioning of the tensioning mechanisms may be set so that if none of the feed elements are being externally driven, the stack of components will come to a halt and rest with a feature, e.g., a seal of adjacent components in contact with the upper and lower feed elements. External input many then be required to feed the enlarged portions, e.g. seals, past the feed elements.

In some examples, the plurality of feed elements further comprise middle feed elements located between the upper feed elements and the lower feed elements. Beneficially, one or more of the middle feed elements may be used to drive the components, i.e. to provide an external input to move the components along the feed path. This may be particularly useful in the examples noted above, to permit the enlarged portions, e.g. seals, of the components to be fed past the upper and lower feed elements. One or more driven feed elements may be provided at other levels. For example, one or more of the feed elements of the upper level and/or the lower level and/or of a level provided above the upper level or below the lower level may be a driven feed element.

In some examples, a spacing of adjacent levels of the feed elements along the feed path is less than a longitudinal length of each of the components.

In some examples, each level of feed elements along the feed path comprises at least three feed elements. More than three feed elements may be provided at each level, for example four or five. At least three feed elements at each level, and preferably at least four feed elements at each level is preferred in order to help maintain the circularity of the components during feeding.

In some examples, the plurality of feed elements are distributed circumferentially around a longitudinal axis of the feed path at two, three, four, or more positions. The feed elements may be regularly distributed around the circumference of the feed path.

In preferred examples, the plurality of feed elements comprises or consists of a plurality of feed wheels. However, the present disclosure extends to feed elements taking other forms. For example, the feed elements may comprise or consist of tracked elements, e.g. caterpillar tracks, or reciprocating pads, or reciprocating fingers, etc.

In some examples, one or more of the feed wheels are driven wheels configured to be driven in rotation to feed the components along the feed path.

In some examples, the one or more driven wheels are driven by hand-power or motor-power.

In some examples, the conveyor further comprises one or more handles coupled to the one or more driven wheels for rotating the driven wheels. The handles may be rotated, for example, by hand.

Preferably, at least one driven wheel is provided at each of at least two levels along the feed path. For example, at least one driven wheel may be provided at each of the upper and middle levels, or at each of the middle and lower levels, or at each of the upper, middle and lower levels. Beneficially it can be configured that at least one of the driven wheels will always be spaced from the enlarged portions, e.g. seals, of the components, so that driving force can always be imparted against a body of at least one of the components along the feed path. For example, as noted above, it may be configured that an enlarged portion, e.g. a seal, of adjacent components contacts the upper and lower feed elements, e.g. feed wheels, simultaneously. In such examples, it may be beneficial to ensure that at least one driven feed wheel (or other feed element) is provided at the middle level of feed elements so that drive is imparted against the body of one of the components spaced from the enlarged portions, e.g. seals.

In some examples, the tensioning mechanism comprises a tensioning spring biasing the feed element inwards towards the feed path. Other tensioning mechanisms may also be used. For example, other resilient means may be provided, or a tensioning screw mechanism.

In some examples, the tensioning mechanism further comprises a pre-compression mechanism for selectively setting a pre-compression of the tensioning spring.

In some examples, the frame comprises a connection for removably suspending the conveyor below the tube.

In some examples, the frame comprises an opening at a first end of the frame defining an entrance to the feed path for receiving components discharged from the tube.

In some examples, the frame comprises an opening at a second end of the frame defining an exit of the feed path.

In some examples, the feed path is a linear path through the frame, optionally through a centre of the frame.

In some examples, the components comprise catalyst carriers, and the tube comprises a reactor tube of a tubular reactor. It will be appreciated that when applied to the field of tubular reactors, the components may include components that do or do not contain catalyst material. For example, the components may include catalyst carriers that do contain a catalyst material but also may include other components such as spacer components that are provided within the stack of components to control positioning of the catalyst carriers within the length of the reactor tube and/or ejector components that may be inserted into an upper end of the reactor tube to cause catalyst carriers to be discharged from the lower end of the reactor tube. Typically, such spacer and ejector components do not contain any catalyst material but still comprise components as meant in the present specification.

The components may be tubular components. The components may be generally cylindrical in external shape (although as noted above, possibly comprising one or more protrusions, e.g. seals). The components may be generally right-circular cylindrical in external shape.

In a second aspect the present disclosure provides a system comprising:
a conveyor as claimed in any preceding claim;
a tubular reactor comprising a plurality of reactor tubes; and
a plurality of components;
wherein the conveyor is located in proximity to an outlet of a selected reactor tube for controlling a discharge of the plurality components from the selected reactor tube.

In some examples the conveyor is removably attachable to the tubular reactor in proximity to an outlet of a selected reactor tube.

In some examples the conveyor is removable attachable by being suspended from a lower tube sheet of the tubular reactor.

Beneficially, the conveyor may be sequentially moved from beneath one reactor tube to another as needed. Also, the conveyor may be removed from the tubular reactor when not needed so as not to impede fluid flow in use of the tubular reactor.

In a third aspect the present disclosure provides a method of controlled discharge of a stack of components from a tube, comprising the steps of:
i) locating a conveyor in proximity to an outlet of the tube, the conveyor comprising a frame and a plurality of feed elements mounted to the frame, the feed elements being distributed around and along a feed path that extends through the frame; and
ii) discharging components from the tube into the conveyor so that they pass along the feed path and in so doing are contacted by the plurality of feed elements;
wherein a level of friction between one or more of the feed elements and the components passing along the feed path is selectively adjustable.

In some examples, locating the conveyor in proximity to the outlet of the tube may comprise attaching the conveyor in proximity the outlet, optionally removably attaching the conveyor in proximity to the outlet.

Preferably, the plurality of feed elements comprises or consists of a plurality of feed wheels. However, as noted above, other types of feed element may be provided.

In some examples, one or more of the feed wheels are driven wheels and a level of rolling friction is adjusted so that the components require feeding through the feed path by rotation of the one or more driven wheels.

In some examples, the components comprise an enlarged portion having a greater diameter than a body of the components and the level of friction is adjusted so that rotation of the one or more driven wheels is required for passage of the enlarged portion past the one or more driven wheels.

In some examples, the one or more driven wheels are driven by hand-power or motor-power.

In some examples, a level of rolling friction between each of the feed wheels and the components passing along the feed path is selectively adjustable.

In preferred examples, each component during at least a portion of its passage along the feed path is contacted by feed elements at at least two levels along the feed path.

In some examples, each component passing along the feed path is contacted around a longitudinal axis of the feed path by feed elements at two, three, four, or more positions.

In some examples, the level of friction is adjusted by using a tensioning mechanism comprising a tensioning spring that biases the feed element inwards towards the feed path. In some examples, the tensioning mechanism further comprises a pre-compression mechanism for selectively setting a pre-compression of the tensioning spring.

In some examples the method further comprises inserting components into an inlet of the tube, wherein the insertion of the components into the inlet of the tube is controlled by the action of discharging the components from the outlet of the tube.

In some examples, the frame is located in proximity to the outlet of the tube. In some examples, the frame is removably attachable in proximity to the outlet of the tube.

In preferred examples, the components comprise catalyst carriers, and the tube comprises a reactor tube of a tubular reactor. Typically, discharge of catalyst carriers from the outlet of the reactor tube will be simultaneously accompanied by insertion of replacement components (e.g. catalyst carriers or ejector components) at an inlet of the reactor tube.

Thus, the conveyor of the present disclosure may be used not only to empty a reactor tube but also as part of a process of replacing the components of a reactor tube by simultaneously inserting and discharging components until the reactor tube contains a new set of components and the previously installed components have all been discharged.

In some examples, the components are discharged from the conveyor into a receptacle, for example bin or drum, for removal through, for example, a manway in the tubular reactor. In some examples, a further conveyancing means such as a chute or hose is connected to the frame of the conveyor to discharge components from the conveyor, for example to outside the tubular reactor or through a manway or opening in the tubular reactor, preferably the bottom of the tubular reactor.

Where the components of the present disclosure are catalyst carriers these may be filled or partially filled with any catalyst suitable for the intended reaction. For example, a Fischer-Tropsch catalyst may be used for the Fischer-Tropsch reaction. Cobalt-containing Fischer-Tropsch catalysts are preferred. The catalyst may be provided as catalyst particles or a catalyst monolith. The catalyst may be provided as a single bed of catalyst or multiple beds of catalyst. The catalyst carrier may be configured to promote axial and/or radial flow through the catalyst. In some embodiments the catalyst carrier may be configured to preferentially promote radial flow through the catalyst.

The catalyst carriers may be formed of any suitable material. Such material will generally be selected to withstand the operating conditions of the tubular reactor. The catalyst carrier may be fabricated from carbon steel, aluminium, stainless steel, other alloys or any material able to withstand the reaction conditions.

### BRIEF DESCRIPTION OF THE DRAWINGS

Embodiments of the present disclosure will now be described, by way of example only, with reference to the accompanying drawings, in which:

FIG. 1 is a schematic side view of a tubular reactor;

FIG. 2 shows a catalyst carrier;

FIG. 3 shows a conveyor according to the present disclosure together with a plurality of catalyst carriers;

FIG. 4 shows the conveyor of FIG. 3 mounted to a lower tube sheet of a tubular reactor;

FIG. 5 shows an enlarged view of a portion of the conveyor of FIG. 3 during the feeding of a plurality of catalyst carriers;

FIG. 6 is a view from above of a portion of the conveyor of FIG. 3 showing feed elements of the conveyor;

FIG. 7 shows a tensioning mechanism of the conveyor of FIG. 3 in a first state and in a second state; and

FIG. 8 shows a schematic cross-sectional view of the conveyor of FIG. 3 feeding a plurality of catalyst carriers.

### DETAILED DESCRIPTION

In the following, aspects and embodiments of the present disclosure will be described, by way of example only, with reference to components in the form of catalyst carriers for use with a vertically orientated tubular reactor having a plurality of vertical reactor tubes extending between an upper tube sheet and a lower tube sheet. However, it will be understood that the present disclosure may also be applied to other configurations of tubular reactor that may adopt other orientations and other components being discharged from other tubes.

Additionally, in this specification any reference to orientation; for example, terms such as top, bottom, upper, lower, above, below and the like is used with regard to the orientation of the parts as illustrated in the drawings being referenced but is not to be seen as restrictive on the potential orientation of such parts in actual use. For example, a part described as being orientated vertically may also be orientated horizontally.

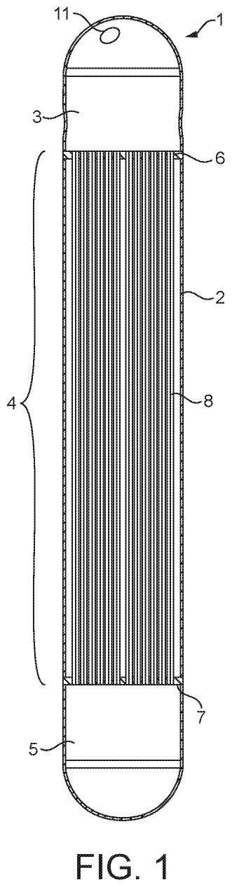

FIG. 1 shows a typical layout of a tubular reactor 1 of the present disclosure. The tubular reactor 1 comprises a housing 2. The interior of the housing may be divided into a head space 3, a heat-exchange zone 4 and a footer space 5 by two tube sheets-an upper tube sheet 6 and a lower tube sheet 7. The upper tube sheet 6 separates the head space 3 from the heat-exchange zone 4. The lower tube sheet 7 separate the footer space 5 from the heat-exchange zone 4.

A plurality of reactor tubes 8 extend between the upper tube sheet 6 and the lower tube sheet 7. A large number of reactor tubes 8 may be provided, for example between 20 and 5000 reactor tubes 8 may be present. Each reactor tube 8 may have, for example, an internal diameter of between 20 and 150 mm. In some embodiments the internal diameter may be about 85 mm.

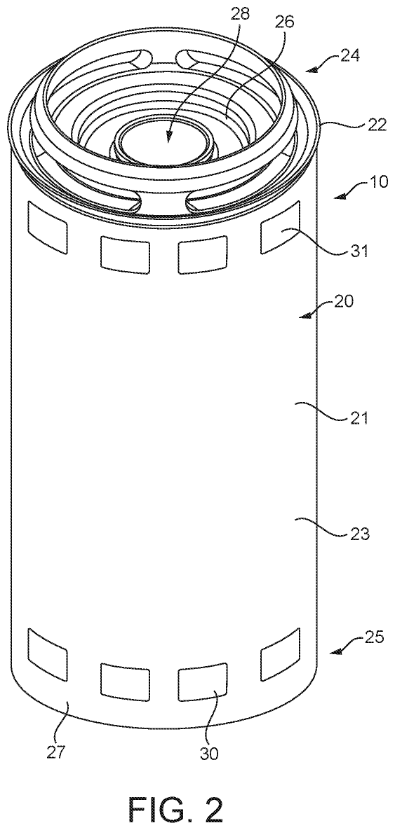

Each reactor tube 8 is intended to be filled or substantially filled with a stacked arrangement of catalyst carriers 10 (for example, as shown in FIG. 2). In particular, it is typically desired that the catalyst carriers 10 cover all or substantially all of the length of the reactor tube 8 between the upper tube sheet 6 and the lower tube sheet 7, i.e. that they cover all or substantially all of the length of the heat-exchange zone 4.

The head space 3 may provide access to an upper end of the reactor tubes 8 to allow loading of the catalyst carriers 10 into the reactor tubes 8. An access opening 11 may be provided in the housing 2 to allow access to the head space 3. The access opening 11 may, for example, be a manhole or other access panel that can be selectively opened and closed.

The footer space 5 may provide access to the lower end of the reactor tubes 8 to allow unloading of the catalyst carriers 10 from the reactor tubes 8.

To better understand the present disclosure, an example of a general configuration of a component in the form of a catalyst carrier 10 will be described with reference to FIG. 2. However, it will be understood that the catalyst carriers 10 may take various forms. For example, as well as the example described herein, the catalyst carriers 10 may take other general configurations including but not limited to those disclosed in WO2011/048361, WO2012/136971 and WO2016/050520, the contents of which are herein incorporated by reference in their entirety.

Each catalyst carrier 10 may generally comprise a container 20 that is sized such that it is of a smaller dimension than the internal dimension of the reactor tube 8 into which it is to be placed in use. Typically, a seal 22 will be provided that is sized such that it interacts with the inner wall of the reactor tube 8 when the catalyst carrier 10 is in position within the reactor tube 8. Parameters such as carrier length and diameter may be selected to accommodate different reactions and configurations of reactor tube 8.

As shown in FIG. 2, the container 20 comprises an elongate body 21 having an outer wall 23 extending between an upper end 24 and a bottom end 25. A lid portion 26 is provided at the upper end 24 that at least partially closes off the elongate body 21 at the upper end 24. A skirt portion 27 is provided at the bottom end 25. The seal 22 is located towards the upper end 24 and preferably close to, for example just below, the lid portion 26.

The lid portion 26 is provided with a central aperture 28 that permits ingress of fluid into the container 20 in use.

As shown in FIG. 2, the outer wall 23 may be provided with a plurality of apertures configured to permit fluid transfer across the outer wall 23. At the bottom end 25 of the outer wall 23, the skirt portion 27 may comprise a plurality of bottom apertures 30. The bottom apertures 30 may be spaced around the circumference of the elongate body 21. Each bottom aperture 30 may be, for example, of a square or rectangular shape. Similarly, at the upper end 24 of the outer wall 23, a plurality of upper apertures 31 may be provided. The upper apertures 31 may be spaced around the circumference of the elongate body 21. Each upper aperture 31 may be, for example, of a square or rectangular shape.

The catalyst carrier 10 may define an annular container for holding catalyst in use. The annular container may comprise a perforated inner container wall that defines an inner channel and a perforated outer container wall that may be concentrically arranged about the perforated inner container wall and within the outer wall 23. An annular top surface, defined by a part of the lid portion 26, may close an upper end of the annular container and an annular bottom surface may close a lower end of the annular container.

The seal 22 may be sufficiently compressible to accommodate the smallest diameter of the reactor tube 8. The seal 22 may generally be a flexible, sliding seal. The seal 22 may engage against an inner surface of the reactor tube 8 such that liquids and gases passing along the reactor tube 8 are preferentially directed to flow through an interior of the catalyst carrier 10. The seal 22 may, for example, be configured to form a sliding seal against the inner surface of the reactor tube 8.

In the illustrated example of FIG. 2, the seal 22 may comprise a deformable flange extending from the outer wall 23. The flange may be sized to be larger than the internal diameter of the reactor tube 8 such that as the catalyst carrier 10 is inserted into the reactor tube 8 it is deformed to fit inside and interact with the reactor tube 8.

Further details of the construction of such catalyst carriers 10 can be found in WO2011/048361, WO2012/136971 and WO2016/050520, the contents of which are herein incorporated by reference in their entirety.

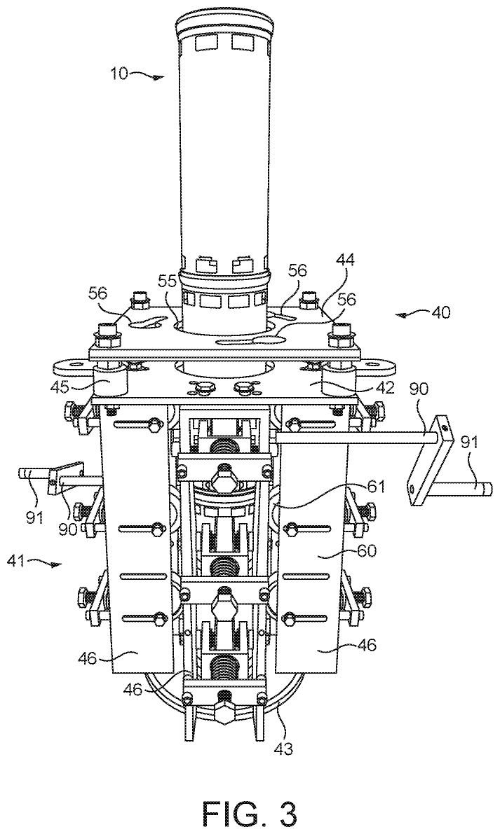

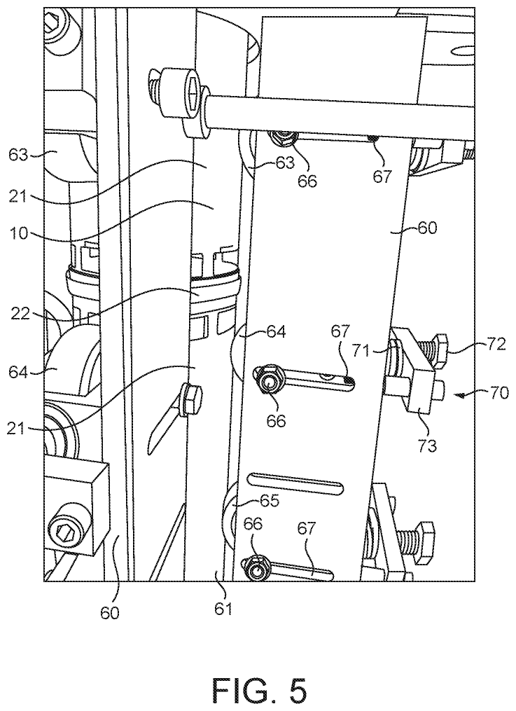

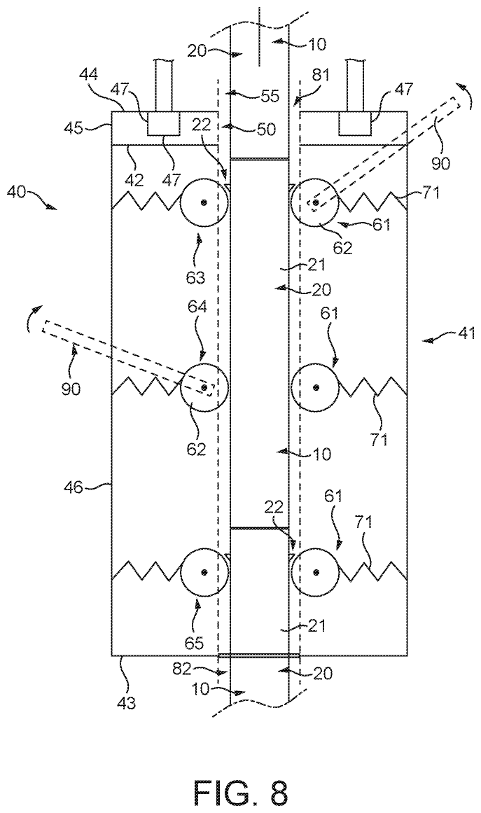

According to the present disclosure, a conveyor 40 is provided for controlled discharge of a stack of components in the form of the catalyst carriers 10 from a tube in the form of the reactor tube 8. An example of the conveyor 40 is shown in FIGS. 3 to 7, and schematically in FIG. 8.

The conveyor of FIG. 3 comprises a frame 41 that may comprise an upper plate 42, a lower ring 43 and a plurality of wheel sub-frames 46 that may extend there between. Optionally, an additional plate 44 may be provided above and spaced from the upper plate 42 and connected there to by connector bolts 45. The additional plate 44 may form an attachment plate for removably attaching the frame 41 to the lower tube sheet 7.

The additional plate 44 may comprise a central aperture 55. The upper plate 42 may also comprise a central aperture 50 that may be aligned with the central aperture 55. Together, the central apertures 50, 55 may define an inlet 81 to a feed path 80 that extends through the frame 41 to an outlet 82 optionally defined by the lower ring 43. The feed path 80 is preferably a linear path and optionally is coincident with a central, longitudinal axis of the frame 41. The wheel sub-frames 46 may be distributed about the feed path 80, optionally at regular intervals. In the illustrated example of the Figures, four wheel sub-frames 46 are provided at 90 degrees spacing.

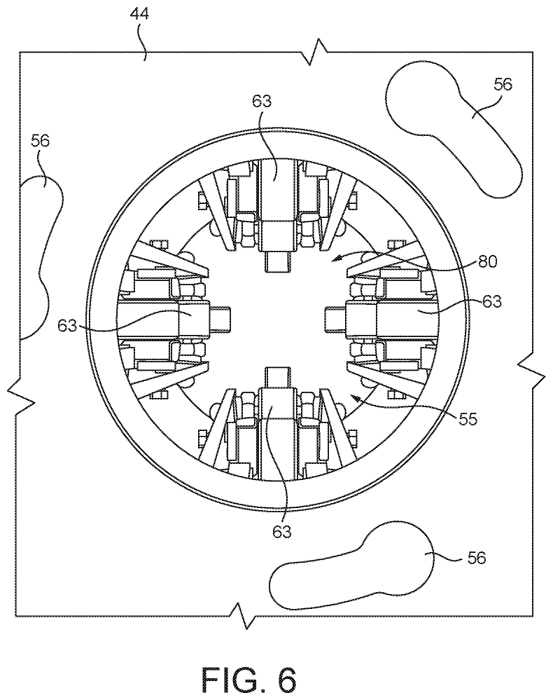

The conveyor 40 further comprises a plurality of feed elements mounted to the frame 41. The feed elements may preferably be in the form of feed wheels 61. The feed wheels 61 may each be mounted to the wheel sub-frames 46. Each wheel sub-frame 46 may comprise two parallel spaced apart plates that define a space there between for housing at least a portion of the feed wheels 61. As shown in FIG. 6, each feed wheel 61 may be rotatably mounted by means of a feed wheel axle 66 that extends through adjustment slots 67 in each of the spaced apart plates of the wheel sub-frame 46.

The feed wheels 61 may be grouped into upper feed wheels 63, middle feed wheels 64 and lower feed wheels 65 that may be located along the length of the frame 41, and in particular along the length of the wheel sub-frames 46. The upper feed wheels 63 may be located closest to the inlet 81, the lower feed wheels 65 located closest to the outlet 82 and the middle feed wheels 84 located there between. Preferably, a spacing between the upper feed wheels 63 and the lower feed wheels 65 is substantially equal to the longitudinal length of the each of the catalyst carriers 10. Preferably, a spacing of adjacent levels of the feed wheels 61 along the feed path 80 is less than a longitudinal length of each of the catalyst carriers 10.

The feed wheels 61 are distributed around and along the feed path 80, as shown in FIGS. 6 and 8, so that the feed wheels 61 contact, in use, the catalyst carriers 10 passing through the frame 41 along the feed path 80.

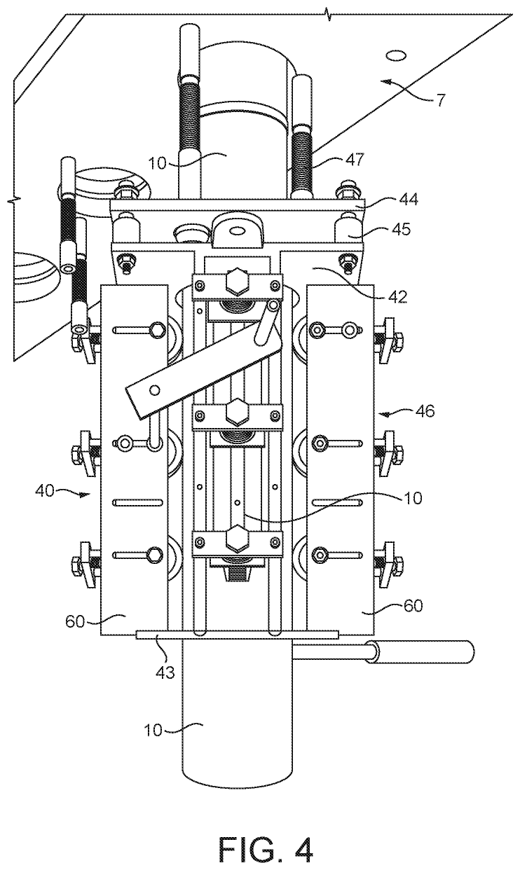

Each level of feed wheels 61 along the feed path 80 may comprise at least three feed wheels, for example four feed wheels 61 as shown in the illustrated example of FIG. 4.

Preferably, one or more of the feed wheels 61 are driven wheels 62 configured to be driven in rotation to feed the catalyst carriers 10 along the feed path 80. The driven wheels 62 may be driven by hand-power or motor-power. In the illustrated example of the Figures, the driven wheels 62 may be manually turned by use of a driving crank 90 and handle 91 connected to the driven wheel 62. Preferably, at least one driven wheel 62 is provided at each of at least two levels along the feed path 80. In the illustrated example, and as shown schematically in FIG. 8, a first driven wheel 62 is one of the upper feed wheels 63 and a second driven wheel 62 is one of the middle feed wheels 64.

One or more of the feed wheels 61 of the conveyor 40 comprises a tensioning mechanism for adjusting a level of friction between the or each feed wheel 61 and the catalyst carriers 10 passing through the frame 41 along the feed path 80. Optionally, each of the feed wheels 61 comprises a tensioning mechanism.

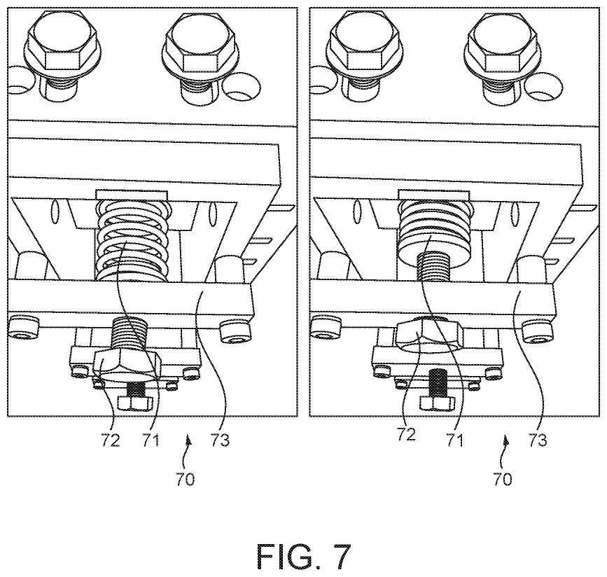

The tensioning mechanism may comprise a tensioning spring 71 biasing the feed wheel 61 inwards towards the feed path 80. The tensioning mechanism may further comprise a pre-compression mechanism for selectively setting a pre-compression of the tensioning spring 71. In the illustrated example, as most clearly seen in FIG. 7, the pre-compression mechanism comprises a mounting bar 73 fixedly attached to its wheel sub-frame 46 and a tensioning bolt 72. The tensioning spring 71 is located between the mounting bar 73 and an inner end of the tensioning bolt 72. The tensioning bolt 72 extends through the mounting bar 73 and can be rotated in both rotational senses to respectively increase or decrease the pre-compression of the tensioning spring 71 by moving the inner end of the tensioning bold (and hence the outer end of the tensioning spring 71) respectively inwards or outwards. The left hand part of FIG. 6 illustrates the pre-compression mechanism having a relatively low level of pre-compression and the right hand part of FIG. 6 illustrates the pre-compression mechanism having a relatively high level of pre-compression.

As shown in FIG. 4, the conveyor 40 may be configured to be located in proximity to an outlet of a reactor tube 8, for example by being attached to, optionally suspended from, the lower tube sheet 7. The frame 41 may comprise a connection for removably suspending the conveyor 40 below the reactor tube 8. In the illustrated example, three mounting bosses 47 extend downwards from the lower tube sheet 8, each having an enlarged distal end, for example the pivot disclosed in WO2022/064211. The attachment plate 44 may be provided with three keyway apertures 56, as visible in FIGS. 3 and 6 that may enable the conveyor 40 to be attached below the outlet of the reactor tube in a bayonet-style connection by engaging the enlarged heads of the mounting bosses 47 in the enlarged portions of the keyway apertures 56 and rotating the conveyor 40. The conveyor 40 may thus be configured to be located in proximity to an outlet of a reactor tube 8.

In use, the controlled discharge of the catalyst carriers 10 may be achieved by the following steps:
i) locating, for example attaching, the conveyor 40 in proximity to the outlet of the reactor tube 8; and
ii) discharging the catalyst carriers 10 from the reactor tube 8 into the conveyor 40 so that they pass along the feed path 80 and in so doing are contacted by the plurality of feed wheels 61.

As noted above a level of friction between the feed wheels 61 and the catalyst carriers 10 passing along the feed path 80 is selectively adjustable, for example by adjustment of the tensioning mechanisms.

As noted above, the catalyst carriers 10 may comprise an enlarged portion, e.g. the seal 22, having a greater diameter than the catalyst carriers body 21 and the level of friction may be adjusted so that rotation of one or more of the driven wheels 62 is required for passage of the enlarged portion past the driven wheels 62.

Preferably, each catalyst carrier 10, during at least a portion of its passage along the feed path 80, is contacted by feed wheels 61 at at least two levels along the feed path 80.

Discharge of the catalyst carriers 10 out of the outlet of the reactor tube 8 into the inlet 81 of the feed path 80 may be achieved or assisted or accompanied by insertion of catalyst carriers 10 (or other components, e.g. ejector components) into an upper end of the reactor tube 8 such that the stack of catalyst carriers 10 within the reactor tube is moved downwards sequentially by or along with each insertion of a component at the upper end.

In some preferred examples, discharge of catalyst carriers 10 from the outlet of the reactor tube 8 is accompanied by simultaneous insertion of catalyst carriers 10 into the inlet of the reactor tube 8. In particular, discharge of the catalyst carriers 10 may move the stack of catalyst carriers 10 downwards within the reactor tube 8 permitting catalyst carriers 10 to be inserted into the inlet of the reactor tube 8 to fill the space created at the upper end of the reactor tube 8. Optionally, the catalyst carriers 10 in these and other examples may be non-self-supporting catalyst carriers 10.

The conveyor 40 may enable the insertion of the catalyst carriers 10 into the inlet of the reactor tube 8 to be controlled by the action of discharging the catalyst carriers 10 from the outlet of the reactor tube 8, rather than the other way round.

Optionally, the lower tube sheet 7 and/or the conveyor 40, e.g. the additional plate 44, may be provided with means for preventing discharge of catalyst carriers 10 from the reactor tube 8. For example, one or more shutters, for example moon-shaped discs (e.g. as described in WO2022/064211, the contents of which are herein incorporated by reference in their entirety), may be pivoted at least partially across the outlet of the reactor tube 8 or across the central aperture 55 of the additional plate 44 to prevent passage of a catalyst carrier 10. This may be beneficial by preventing discharge of catalyst carriers 10 out of the reactor tube 8 while the conveyor 40 is being mounted to the lower tube sheet 7. Once the conveyor 40 is correctly mounted the shutter(s) may be withdrawn so as to clear the outlet of the reactor tube 8 and the inlet 81 of the feed path 80.

Further aspects of the present disclosure are set out in the following clauses:
Clause 1. A conveyor for controlled discharge of a stack of components from a tube, comprising:
   i) a frame configured to be located in proximity to an outlet of the tube; and
   ii) a plurality of feed elements mounted to the frame, the feed elements being distributed around and along a feed path that extends through the frame so as to contact, in use, components passing through the frame along the feed path;
   wherein one or more of the feed elements comprises a tensioning mechanism for adjusting a level of friction between said one or more of the feed elements and the components passing through the frame along the feed path.
Clause 2. The conveyor of clause 1, wherein each of the plurality of feed elements comprises a tensioning mechanism.
Clause 3. The conveyor of clause 1 or clause 2, wherein the plurality of feed elements comprise feed elements at two, optionally at three or more, levels along the feed path.
Clause 4. The conveyor of clause 3, wherein the plurality of feed elements comprise upper feed elements and lower feed elements.
Clause 5. The conveyor of clause 4, wherein a spacing between the upper feed elements and the lower feed elements is substantially equal to the longitudinal length of the each of the components.
Clause 6. The conveyor of clause 4 or clause 5, wherein the plurality of feed elements further comprise middle feed elements located between the upper feed elements and the lower feed elements.
Clause 7. The conveyor of any one of clauses 3 to 6, wherein a spacing of adjacent levels of the feed elements along the feed path is less than a longitudinal length of each of the components.
Clause 8. The conveyor of any one of clauses 3 to 7, wherein each level of feed elements along the feed path comprises at least three feed elements.
Clause 9. The conveyor of any preceding clause, wherein the plurality of feed elements are distributed circumferentially around a longitudinal axis of the feed path at two, three, four, or more positions.
Clause 10. The conveyor of any preceding clause, wherein the plurality of feed elements comprises or consists of a plurality of feed wheels.
Clause 11. The conveyor of clause 10, wherein one or more of the feed wheels are driven wheels configured to be driven in rotation to feed the components along the feed path.
Clause 12. The conveyor of clause 11, wherein the one or more driven wheels are driven by hand-power or motor-power.
Clause 13. The conveyor of clause 11 or clause 12, further comprising one or more handles coupled to the one or more driven wheels for rotating the driven wheels.
Clause 14. The conveyor of any one of clauses 11 to 13, wherein at least one driven wheel is provided at each of at least two levels along the feed path.
Clause 15. The conveyor of any preceding clause, wherein the tensioning mechanism comprises a tensioning spring biasing the feed element inwards towards the feed path.
Clause 16. The conveyor of clause 15, wherein the tensioning mechanism further comprises a pre-compression mechanism for selectively setting a pre-compression of the tensioning spring.
Clause 17. The conveyor of any preceding clause, wherein the frame comprises a connection for removably suspending the conveyor below the tube.
Clause 18. The conveyor of clause 17, wherein the connection comprises a bayonet-style connection.
Clause 19. The conveyor of any preceding clause, wherein the frame comprises an opening at a first end of the frame defining an entrance to the feed path for receiving components discharged from the tube.
Clause 20. The conveyor of any preceding clause, wherein the frame comprises an opening at a second end of the frame defining an exit of the feed path.
Clause 21. The conveyor of any preceding clause, wherein the feed path is a linear path through the frame, optionally through a centre of the frame.
Clause 22. The conveyor of any preceding clause, wherein the components comprise catalyst carriers, and the tube comprises a reactor tube of a tubular reactor.
Clause 23. A system comprising:
   a conveyor as set out in any preceding clause;
   a tubular reactor comprising a plurality of reactor tubes; and
   a plurality of components;
   wherein the conveyor is locatable in proximity to an outlet of a selected reactor tube for controlling a discharge of the plurality components from the selected reactor tube.
Clause 24. The system of clause 23, wherein the conveyor is removable attachable in proximity to the outlet of the selected reactor tube by being suspended from a lower tube sheet of the tubular reactor.
Clause 25. A method of controlled discharge of a stack of components from a tube, comprising the steps of:
   i) locating a conveyor in proximity to an outlet of the tube, the conveyor comprising a frame and a plurality of feed elements mounted to the frame, the feed elements being distributed around and along a feed path that extends through the frame; and
   ii) discharging components from the tube into the conveyor so that they pass along the feed path and in so doing are contacted by the plurality of feed elements;
   wherein a level of friction between one or more of the feed elements and the components passing along the feed path is selectively adjustable.
Clause 26. The method of clause 25, wherein locating the conveyor in proximity to the outlet of the tube comprises attaching the conveyor in proximity the outlet, optionally removably attaching the conveyor in proximity to the outlet.
Clause 27. The method of clause 25 or clause 26, wherein the plurality of feed elements comprises or consists of a plurality of feed wheels.
Clause 28. The method of clause 27, wherein one or more of the feed wheels are driven wheels and a level of rolling friction is adjusted so that the components require feeding through the feed path by rotation of the one or more driven wheels.
Clause 29. The method of clause 28, wherein the components comprise an enlarged portion having a greater diameter than a body of the components and the level of friction is adjusted so that rotation of the one or more driven wheels is required for passage of the enlarged portion past the one or more driven wheels.
Clause 30. The method of any one of clauses 28 to 29, wherein the one or more driven wheels are driven by hand-power or motor-power.
Clause 31. The method of any one of clauses 27 to 30, wherein a level of rolling friction between each of the feed wheels and the components passing along the feed path is selectively adjustable.
Clause 32. The method of any one of clauses 26 to 31, wherein each component during at least a portion of its passage along the feed path is contacted by feed elements at at least two levels along the feed path.
Clause 33. The method of any one of clauses 26 to 32, wherein each component passing along the feed path is contacted around a longitudinal axis of the feed path by feed elements at two, three, four, or more positions.
Clause 34. The method of any one of clauses 26 to 33, wherein the level of friction is adjusted by using a tensioning mechanism comprising a tensioning spring that biases the feed element inwards towards the feed path.
Clause 35. The method of clause 34, wherein the tensioning mechanism further comprises a pre-compression mechanism for selectively setting a pre-compression of the tensioning spring.
Clause 36. The method of any one of clauses 26 to 35, further comprising inserting components into an inlet of the tube, wherein the insertion of the components into the inlet of the tube is controlled by the action of discharging the components from the outlet of the tube.
Clause 37. The method of any one of clauses 26 to 36, wherein the components comprise catalyst carriers, and the tube comprises a reactor tube of a tubular reactor.

1. A conveyor for controlled discharge of a stack of components from a tube, comprising:
i) a frame configured to be located in proximity to an outlet of the tube; and
ii) a plurality of feed elements mounted to the frame, the feed elements being distributed around and along a feed path that extends through the frame so as to contact, in use, components passing through the frame along the feed path;
wherein one or more of the feed elements comprises a tensioning mechanism for adjusting a level of friction between said one or more of the feed elements and the components passing through the frame along the feed path.

2. The conveyor of claim 1, wherein the plurality of feed elements comprise feed elements at two, optionally at three or more, levels along the feed path.

3. The conveyor of claim 2, wherein the plurality of feed elements comprise upper feed elements and lower feed elements.

4. The conveyor of claim 3, wherein a spacing between the upper feed elements and the lower feed elements is substantially equal to the longitudinal length of the each of the components.

5. The conveyor of claim 3, wherein the plurality of feed elements further comprise middle feed elements located between the upper feed elements and the lower feed elements.

6. The conveyor of claim 2, wherein a spacing of adjacent levels of the feed elements along the feed path is less than a longitudinal length of each of the components.

7. The conveyor of claim 1, wherein the plurality of feed elements comprises or consists of a plurality of feed wheels.

8. The conveyor of claim 7, wherein one or more of the feed wheels are driven wheels configured to be driven in rotation to feed the components along the feed path.

9. The conveyor of claim 7, further comprising one or more handles coupled to the one or more driven wheels for rotating the driven wheels.

10. The conveyor of claim 7, wherein at least one driven wheel is provided at each of at least two levels along the feed path.

11. The conveyor of claim 1, wherein the tensioning mechanism comprises a tensioning spring biasing the feed element inwards towards the feed path.

12. The conveyor of claim 11, wherein the tensioning mechanism further comprises a pre-compression mechanism for selectively setting a pre-compression of the tensioning spring.

13. The conveyor of claim 1, wherein the frame comprises a connection for removably suspending the conveyor below the tube.

14. The conveyor of claim 1, wherein the components comprise catalyst carriers, and the tube comprises a reactor tube of a tubular reactor.

15. A system comprising:
a conveyor as claimed in claim 1;
a tubular reactor comprising a plurality of reactor tubes; and
a plurality of components;
wherein the conveyor is located in proximity to an outlet of a selected reactor tube for controlling a discharge of the plurality components from the selected reactor tube.

16. The system of claim 15, wherein the conveyor is removable attachable in proximity to the outlet of the selected reactor tube by being suspended from a lower tube sheet of the tubular reactor.

17. A method of controlled discharge of a stack of components from a tube, comprising the steps of:
i) locating a conveyor in proximity to an outlet of the tube, the conveyor comprising a frame and a plurality of feed elements mounted to the frame, the feed elements being distributed around and along a feed path that extends through the frame; and
ii) discharging components from the tube into the conveyor so that they pass along the feed path and in so doing are contacted by the plurality of feed elements;
wherein a level of friction between one or more of the feed elements and the components passing along the feed path is selectively adjustable.

18. The method of claim 17, wherein locating the conveyor in proximity to the outlet of the tube comprises attaching the conveyor in proximity the outlet, optionally removably attaching the conveyor in proximity to the outlet.

19. The method of claim 18, wherein the plurality of feed elements comprises or consists of a plurality of feed wheels.

20. The method of claim 19, wherein one or more of the feed wheels are driven wheels and a level of rolling friction is adjusted so that the components require feeding through the feed path by rotation of the one or more driven wheels.

21. The method of claim 20, wherein the components comprise an enlarged portion having a greater diameter than a body of the components and the level of friction is adjusted so that rotation of the one or more driven wheels is required for passage of the enlarged portion past the one or more driven wheels.

22. The method of claim 18, wherein each component during at least a portion of its passage along the feed path is contacted by feed elements at at least two levels along the feed path.

23. The method of claim 18, wherein the level of friction is adjusted by using a tensioning mechanism comprising a tensioning spring that biases the feed element inwards towards the feed path.

24. The method of claim 23, wherein the tensioning mechanism further comprises a pre-compression mechanism for selectively setting a pre-compression of the tensioning spring.

25. The method of claim 18, further comprising inserting components into an inlet of the tube, wherein the insertion of the components into the inlet of the tube is controlled by the action of discharging the components from the outlet of the tube.
